(19) United States
(12) Patent Application Publication
(10) Pub. No.: US 2012/0215618 A1
(43) Pub. Date: Aug. 23, 2012

(54) System And Method For Implementing A Social Coupon String

(75) Inventors: Darin Myman, Howell, NJ (US); Douglas W. Walsh, Monmouth Junction, NJ (US); Peter Shelus, South Plainfield, NJ (US)

(73) Assignee: PeopleString Corporation, Red Bank, NJ (US)

(21) Appl. No.: 13/092,543

(22) Filed: Apr. 22, 2011

Related U.S. Application Data
(60) Provisional application No. 61/445,222, filed on Feb. 22, 2011.

(51) Int. Cl. G06Q 30/00

(52) U.S. Cl. 705/14.35; 705/14.1

(57) ABSTRACT

A method and a system for an increased value of a Coupon are provided. The increased value is achieved by a first number of computing device users who have confirmed the Coupon. A second number of computing device users increases the value of the Coupon to a new value by confirming the Coupon. Confirmation of a Coupon can be achieved by activating a link. Confirmation can also be achieved by sending an e-mail. A first Coupon string contains contacts including a first user of a starting user. The first user becomes a starting user of a next string by activating a new string of contacts. Different coupon strings may achieve different end values of a Coupon. A Coupon may be associated with a special interest. A special interest may be a credit card.

### STATEMENT OF RELATED CASES

This application claims the benefit of U.S. Provisional Patent Application Ser. No. 61/445,222 filed on Feb. 22, 2011, which is incorporated by reference herein in its entirety.

### BACKGROUND OF THE INVENTION

The present invention relates to a system and methods for creating and/or using a social coupon string. In particular, it relates to determining an increased value of a coupon for a product or a service issued from a web page, wherein the coupon has a first value not being zero which is increased to a second value after having been approved of by a first number of on-line viewers and the value may be increased to a third value after it has been approved of by a number of viewers that is incremental to the first number.

Coupons are a known vehicle for enticing consumers to purchase a product or a service. A coupon allows a consumer to obtain from a provider a discount on the purchase of an article or a service when presenting the coupon. A coupon in general has a certain face value that is fixed. In an alternative embodiment a coupon may provide a product or service for free, for instance when purchasing a first service or product. Coupons can be a powerful incentive to convince a consumer to purchase a product or service.

New communication networks, for instance the Internet, enable quick communications between consumers and the creation of communities of people with similar interests. Groupon, Inc. of Chicago provides consumers with a discount which is only validated if a sufficient number of consumers participate. However, this is an all or nothing approach, which may not reward people for their efforts to approve of a product or service. This discount is not a coupon as defined and applied herein as it requires that a purchase is made. One aspect of a coupon is that it is distributed to potential buyers before a purchase is made to incentivize such a purchase. It also does not provide an incentive to grow the number of participants after a minimum number of approvals related to a coupon has been achieved.

Accordingly, new and improved systems and methods for determining a value of an on-line coupon are required.

### SUMMARY OF THE INVENTION

In accordance with an aspect of the present invention methods and systems are provided for creating coupons, including allowing merchants to create coupons by setting price-volume points with a high degree of accuracy. It also provides methods and systems for allowing the coupons to be distributed over a social network and in a viral manner.

In accordance with one aspect of the present invention, a system to provide a coupon related to an organization to a plurality of users is provided. The system includes a plurality of computing devices, a server comprising a processor and a memory, and a network connecting the plurality of computing devices and the server. The server is operable to send a user interface to one of the plurality of computing devices in response to a request to generate a coupon and receive information requested in the user interface from the one of the plurality of computing devices. The information includes an initial non-zero value of the coupon, a first tiered non-zero value of the coupon and the number of required users to obtain the first tiered non-zero value of the coupon. The server stores the initial non-zero value of the coupon, the first tiered non-zero value of the coupon, the number of required users to obtain the first tiered non-zero value of the coupon in the memory.

Additionally, the server can receive information requested in the user interface from the one of the plurality of computing devices including a second tiered non-zero value of the coupon and the number of required users to obtain the second tiered non-zero value of the coupon. The server can store the second tiered non-zero value of the coupon and the number of required users to obtain the second tiered non-zero value of the coupon in the memory.

Additionally, the server can receive information requested in the user interface from the one of the plurality of computing devices including a third tiered non-zero value of the coupon and the number of required users to obtain the third tiered non-zero value of the coupon. The server can store the third tiered non-zero value of the coupon and the number of required users to obtain the third tiered non-zero value of the coupon in the memory.

Additionally, the server can receive information requested in the user interface from the one of the plurality of computing devices, including a fourth tiered non-zero value of the coupon and the number of required users to obtain the third tiered non-zero value of the coupon. The server can store the fourth tiered non-zero value of the coupon and the number of required users to obtain the fourth tiered non-zero value of the coupon in the memory.

In accordance with a further aspect of the present invention, the server can receive an initial request for the coupon from any of the plurality of computing devices and create a coupon string by assigning a unique code to the created coupon, storing the unique code and an associated coupon identification in the memory and initializing the number of users of the coupon string in the memory. In accordance with one aspect of the present invention, the initial request does not have a unique code associated with it.

The server can receive a request for the coupon, the request including the unique code. The server then increments the number of users of the coupon, checking the required number of users of the coupon and if the number of users equals the required number of users then incrementing the value of the coupon by the incremental value of the coupon. The server performs these steps on the string of coupons referenced by the unique code.

The server distributes the coupon in response to the request for the coupon that includes the unique code. This can be accomplished by posting the coupon to a web page. It can also be done by actually sending the coupon to a requester. The transmission can be by email, Facebook, instant messaging, text messaging or the like.

Thus, in accordance with an aspect of the present invention, the distributed coupon is valued in accordance with the number of users that have requested the coupon by using the unique code.

In accordance with another aspect of the present invention, before the number of users is incremented, the server determines whether the request is a duplicate request.

The present invention also contemplates a method wherein a server performs any combination of the steps set forth in the preceding paragraphs.

The present invention also provides a method wherein a merchant creates a coupon having a first non-zero value and having a second non-zero value once a selected number of users request the coupon. A server stores the first non-zero value, the second non-zero value and the selected number of users in a memory. When a request for the coupon is received, the number of users in the memory is incremented. Then it is determined whether the number of users exceeds the selected number of users and, if so, the value of the coupon is increased from the first non-zero value to the second non-zero value.

The coupon is distributed in some fashion in response to the request.

The request for the coupon can be received from an email address, from Facebook, via instant messaging, via text message, or via phone.

In accordance with another aspect of the present invention after the request is receive but before the number of users is incremented, a check is made to determine if the request is a duplicate request.

In accordance with a further aspect of the present invention, requests for the coupon have a code that defines a string of the coupon; and when the request for the coupon is received, the string of the coupon is determined. Then the step of incrementing the number of users is performed on the string of the coupon specified by the code in the request. Also, the step of determining whether the number of users exceeds the selected number of users and, if so, increasing the value of the coupon from the first non-zero value to the second non-zero value is performed on the string of the coupon specified by the code in the request.

In accordance with another aspect of the present invention, a method allows a merchant to create a coupon having a first non-zero value and having a second non-zero value once a selected number of users request the coupon. When receiving an initial request for the coupon is received, a string of the coupon is created, the string having a unique code associated with the coupon and a number of users in the string of the coupon. When a request for the coupon is received and the request has the unique code it is determined whether the number of users in the string exceeds the selected number of users and, if so, the value of the coupon is increased from the first non-zero value to the second non-zero value. The requested coupon is distributed.

In accordance with another aspect of the present invention, a method is provided wherein a second initial request for the coupon is received. The second string of the coupon is created. The second string has a second unique code associated with the coupon and a number of users in the second string of the coupon. When a request for the coupon having the second unique code is received, it is determined whether the number of users in the second string exceeds the selected number of users and, if so, the value of the coupon in the second string is increased from the first non-zero value to the second non-zero value. Then the coupon with the second non-zero value is distributed.

In accordance with a further aspect of the present invention, a merchant creates a coupon having three or more non-zero values and for each of the non-zero values after a first value, a required number of users request the coupon to obtain non-zero values after the first value. When an initial request for the coupon is received, a string of the coupon is created, the string having a unique code associated with the coupon and a number of users in the string of the coupon. When a request for the coupon having the unique code; is received, it is determined whether the number of users in the string exceeds the selected number of users and, if so, the value of the coupon is increased from the first non-zero value to the second non-zero value.

In accordance with another aspect of the present invention, a method is provided wherein a second initial request for the coupon is received and a second string of the coupon is created. The second string has a second unique code associated with the coupon and a number of users in the second string of the coupon. Upon receiving a request for the coupon having the second unique code, it is determined whether the number of users in the second string exceeds the selected number of users and, if so, the value of the coupon is increased from the first non-zero value to the second non-zero value.

In accordance with one embodiment of the present invention, each of the prior steps is performed by a server connected to other computing devices over the internet.

### DESCRIPTION OF THE DRAWINGS

FIG. 1 illustrates a coupon accordance with an aspect of the present invention.

FIG. 2 illustrates a system for a social coupon string in accordance with an aspect of the present invention.

FIG. 3 illustrates a database design in accordance with one or more aspects of the present invention.

FIG. 4 illustrates steps of a method in accordance with an aspect of the present invention.

FIG. 5 illustrates a set of strings in accordance with an aspect of the present invention.

FIG. 6 illustrates steps of a method in accordance with an aspect of the present invention.

FIGS. 7 and 8 illustrate web pages in accordance with one or more aspects of the present invention.

FIG. 9 illustrates steps of a method in accordance with an aspect of the present invention.

FIG. 10 illustrates enabling of strings in accordance with an aspect of the present invention.

FIG. 11 illustrates a merchant interface in accordance with an aspect of the present invention.

FIG. 12 illustrates a computing device in accordance with an aspect of the present invention.

### DESCRIPTION OF A PREFERRED EMBODIMENT

A coupon is well known as a means to obtain a discount for a product. A product herein in one embodiment of the present invention is intended to mean an object or an article, such as a grocery product or a meal in a restaurant. In a further embodiment of the present invention a product is a service. An example of a service is a car repair, a massage, travel or travel privileges. In yet a further embodiment a product is a combination of an article and a service. For instance, when purchasing new car tires one has to pay for the tires and for balancing the wheels. Herein, the term product is intended to mean an article, a service or a combination for an article and a service, unless stated otherwise.

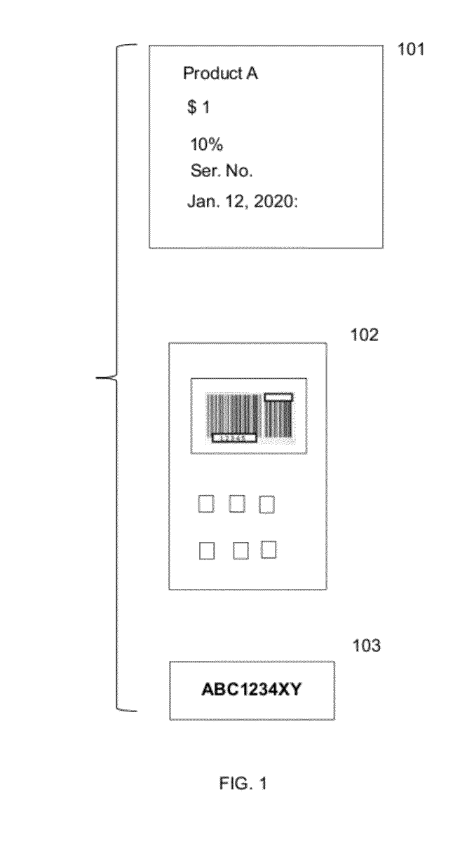

A coupon, in general, used to be, and still is, provided in printed form. This is illustrated in FIG. 1. Diagram 101 illustrates a printed coupon, which may include a product name, a face value or a percentage of discount, a serial number and an expiration date. It may have other relevant information. The diagram(s) provided herein are intended to be illustrative and not limiting. In another embodiment 102 a coupon is downloaded to a mobile computing device and is presented to a provider on a screen of the device. The provider may read the screen to check validity or scan the screen to validate. In a further embodiment, the mobile computing device may generate a message that is received by a computing device of the provider to validate the coupon. In yet a further embodiment a coupon is a code 103. Such a code may for instance be entered on a machine during a purchase or payment. Other forms of coupons, including an image, a video and/or an audio file, are fully contemplated. One current concept of coupons in prior art appears to be that a coupon has a fixed value if it has a value not equal to zero.

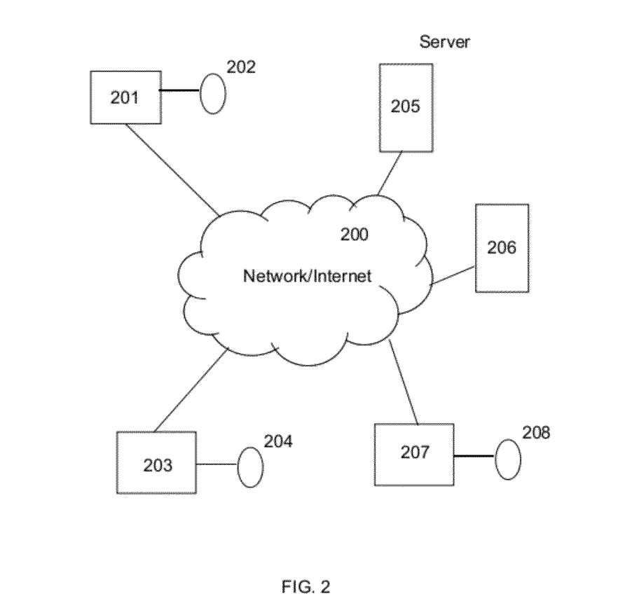

In one embodiment of the present invention, a system is provided as illustrated in FIG. 2, which contains a network 200, which may be the Internet. Connected to the network 200 is at least one server 205. A server 205 may include more than one computing device. However, the server 205 includes at least a processor, memory, a storage device to store and retrieve data, a communication part that connects the server to the network, and preferably a database. The server 205 functions pursuant to an operating system and is programmed with instructions to perform the methods as provided herein. In addition to the network, a plurality of computing devices are provided. For example, FIG. 2 illustrates at least a computing device 201 with a user 202, a computing device 203 with a user 204 and a computing device 207 with a user 208. The computing devices may be mobile computing devices.

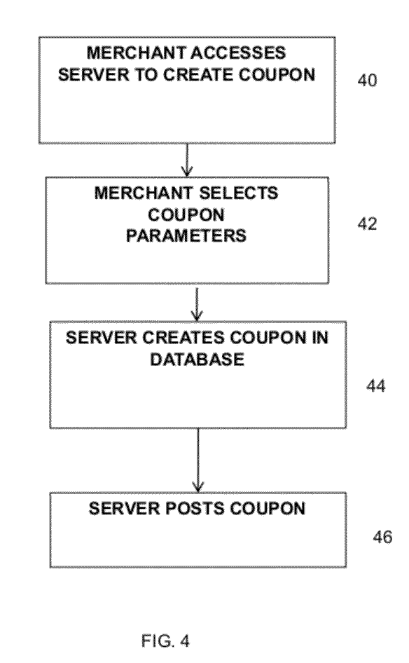

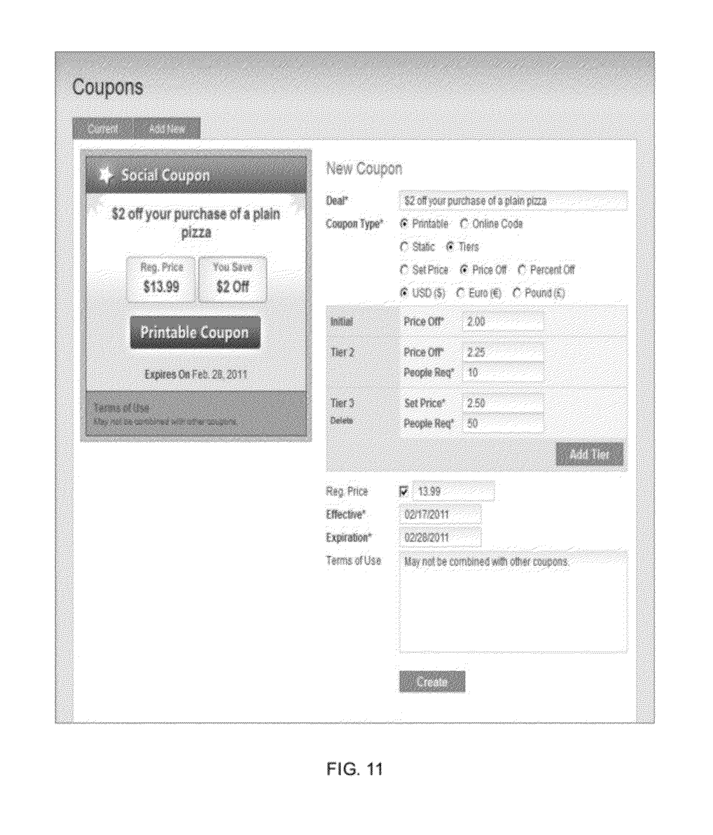

FIG. 4 illustrates steps taken to create a coupon in accordance with an aspect of the present invention. In step 40, a merchant 208 on a local computer 207 accesses a server 205 over the internet 200. The server 205 causes an interface to be sent to the local computer 207. In step 42, the merchant on the local computer 207 uses the interface to create a coupon. An exemplary interface is illustrated in FIG. 11. The merchant enters various parameters to specify the coupon in accordance with an aspect of the present invention.

As shown in FIG. 11, the parameters entered by the merchant include a description of the deal, a type of coupon, whether the coupon will have tiers or not. The concept of coupon tiers, in accordance with an aspect of the invention, will be more described shortly. Essentially, the merchant can set the amount of a discount by the number of people the coupon is distributed to. The amount of the discount and the currency are also entered. The initial price off is entered. If tiers are desired, the price off and the number of participants required are entered. FIG. 11 illustrates that any number of tiers can be added. Alternatively, one tier or no tiers (static) can be selected by the merchant. The regular price is entered by the merchant. The merchant also entered the effective date of the coupon and the expiration date of the coupon. The merchant can also enter terms and conditions of use.

Once the merchant completes entering the coupon information, in step 42, the local computer 207 sends the information to the server 205 over the network 200. In step 44, the server 205 takes the coupon information entered by the merchant in step 40 and creates a new entry in a database to create the coupon.

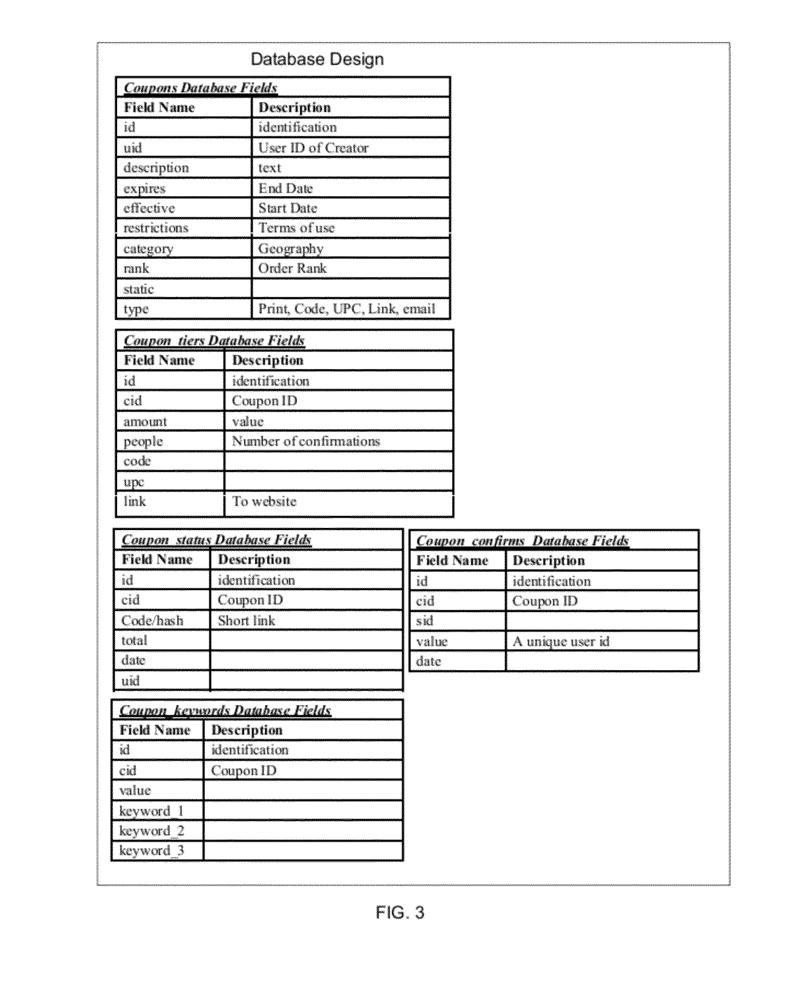

One example of a database design that can implement an aspect of the present invention, that is maintained by the server 205, is illustrated in FIG. 3. The database at the server includes the following example tables: Coupons, Coupon_tiers, Coupon_status, Coupon_confirms, and Coupon_keywords. This database design is merely an example of a database design that enables the methods as provided herein as an aspect of the present invention. Additional designs, field names and arrangement of database fields are possible. The herein provided database design should not be considered limiting.

The Coupons table, in one embodiment of the present invention, includes the following fields: id, uid, active, description, expires, effective, restrictions, category, rank, static and type. The id field is a primary key that is incremented each time a new entry is made in the Coupons table. The uid field is the identification of the merchant that created the coupon. The active field defines whether the coupon is active. The description field provides a description of the coupon. The expires field sets the expiration date of the coupon. The effective field specifies an effective start date of the coupon. The restrictions field specifies any restrictions on the coupon for instance those related to terms of use. For example, it may state that the coupon cannot be combined with any other coupon or offer, that the participants has to be a legal resident of the U.S.A, or any other term or limitation of use. The category field specifies any geographic restrictions on the coupon. For example, a 0 indicates that there are no restrictions. A 1 indicates that the coupon was limited to the United States. A 2 indicates that the coupon is limited to the United States and Canada. Of course, other geographic areas can be specified as well. The rank field specifies an ordering of a coupon in a list of coupons. In accordance with one aspect of the present invention, the rank field is used to allow the server to present coupons from a merchant in an order specified by the merchant when someone wants to view all the coupons available from the merchant. The static field indicates how many tiers the coupon has, if any. Coupon tiers will be explained below. The type field indicates, for example, whether the coupon is printable, a code based coupon, a upc coupon or a link coupon.

The Coupon_tiers table includes the following fields: id, cid, amount, people, code, upc and link. This table implements the concept of tiers in coupons in accordance with an aspect of the present invention. The ‘id’ field is a primary key that is incremented each time a new entry is made in the Coupon_tiers table. The field ‘cid’ provides a relationship back to the Coupon table and is an identification of the appropriate record in the coupon table to be referred to. The ‘amount’ field specifies a value of a tier. The ‘people’ field specifies a number of people required to reach this tier, if applicable. The ‘code’ field specifies a unique value of the coupon upon cashing of the coupon and thus specifies an online coupon code associated with this specific coupon to redeem the coupon on the merchants website or other online medium on the merchant's end. The ‘upc’ field specifies a upc number, if applicable. The ‘link’ field specifies a link the coupon sends a user to upon clicking, if applicable.

The Coupon_status table includes the following fields: id, cid, code, total, date and uid. The id field is a primary key that is incremented each time a new entry is made in the Coupon_status table. The ‘cid’ field specifies the id in the coupon table, thereby specifying the applicable coupon being referred to. The ‘code’ field specifies a short link to the coupon, including a unique hybrid coupon id. The ‘total’ field specifies the total number of people that clicked for the coupon. The ‘uid’ field specifies a user identification number.

The field cid and uid in the Coupon_status table, taken together, are unique.

The Coupon_confirms table includes the following fields: id, cid, sid, and value. The ‘id’ field is a primary key that is incremented each time a new entry is made in the Coupon_confirms table. The ‘cid’ field specifies a coupon id. The ‘sid’ field specifies an id in the Coupon_status table. The ‘value’ field specifies a unique identifier related to a user, whether a user-id, IP address, e-mail address, or any other form of identification.

The Coupon_keywords table includes the following fields: id, cid, value. The ‘id’ field is a primary key that is incremented each time a new entry is made in the Coupon_keywords table. The ‘cid’ field specifies a coupon id. The ‘value’ field specifies a keyword.

It is to be understood that the list of database fields and the naming of database fields in FIG. 3 is an exemplary example. Additional or fewer fields may be used and database fields may be provided with different names. However, the database design as provided herein and illustrated in FIG. 3 describes how a coupon string is enabled in accordance with an aspect of the present invention.

Then, in step 44, the server 205 creates a new record in the Coupons table. After creating a new entry for the primary key, id, the server 205 also enters the merchant's id in the field uid. It also sets the active field to ACTIVE. The value ACTIVE can be a Boolean value (0 or 1) which is preferred or a TEXT value. It enters the description of the coupon provided by the merchant in the description field. It enters the expiration date of the coupon provided by the merchant in the expires field. It enters an effective start date provided by the merchant in the effective field. It enters any restrictions on the coupon provided by the merchant in the restrictions field. By way of example, a coupon may be limited by legal residency, or age 18 or over. It enters the category provided by the merchant in the category field. In enters the order ranking provided by the merchant in the rank field. It enters the number of tiers of the coupon in the tiers field. It also enters the type of coupon specified by the merchant in the type field.

When the merchant is creating the coupon, the merchant also specifies how many tiers the coupon has. As described above, this information is entered in the tiers field in the Coupons table. The coupon can be static, thereby having a single tier. In this case, the coupon would have a static or steady value and would not increase in value through distribution in accordance with an aspect of the present invention. In this case, a 0 is entered into the ‘people’ field in the Coupons_tiers table.

On the other hand, in accordance with an aspect of the present invention, the coupon can have two or more tiers. In accordance with this aspect of the invention, once a certain number of people have accepted the coupon, the value of the coupon increases. In accordance with another aspect of the present invention, the merchant has the ability to control the tiers. The merchant can create a second tier that requires a selected number of people to accept the coupon. For example, the merchant can program the system so that if ten (10) people accept the coupon, the coupon increases in value from $5.00 to $5.50. To do so, the server 205 takes the information from the merchant specifying this tier and enters the coupon id (cid) in the Coupon_tiers table which is a unique identifier for the affected coupon. The value of the coupon upon completion of this tier is also entered in the amount field in the Coupon_tiers table. Thus, in this example, $5.50 is entered. The number of people required to complete the tier so as to increase the value of the coupon in accordance with an aspect of this invention is taken from the merchant and stored in the people field of the Coupon_tiers table. In this example, 10 would be entered in the people field.

Multiple tiers can be created by the merchant and entered into the database by the server 205. Thus, the present invention allows the merchant to control volume and price points accurately. If, for example, the merchant wanted to increase the value of the coupon to $5.90 if another twenty people accept the coupon, then another entry would be made in the Coupon_tiers table. In this case, the coupon id (cid) would be entered again. $5.90 would be entered into the amount field in the Coupon_tiers table and 30 would be entered into the people field of the Coupon_tiers table. The remaining fields are entered in the manner described above. In one embodiment of the present invention a next tier is decided upon achieving a total number of confirmations. In another embodiment of the present invention, a next tier is decided upon an increment of a number of confirmations relative to an earlier decision point. Data to decide the actual status of the coupon and to set a next tier in one embodiment of the present invention is pulled dynamically from the server. For instance, the moment a number of confirmations has reached a critical number N, the status of the coupon is automatically set to a new tier, including its tier related value, if that is applicable. If the merchant wanted a next tier where the coupon value would be increased to $6.25 if another thirty people accept the coupon, then the merchant would enter that information in step 10 and transmit it to the server 205 in step 42. The server 205 would then cause a new record to be created in the Coupon_tiers table. In this case, $6.25 would be entered into the value field and 30 as an incremental value or 60 as an absolute value would be entered into the people field.

It should be apparent that any number of tiers can be created. Each tier can have a selected value that can be attained when a selected number of people accept the coupon. This allows a merchant to accurately control his or her price-volume points.

A tier as illustrated herein is generally formed by a group of coupon confirmations, for instance 5 or 10 confirmations. After such a number of confirmations the value of the coupon jumps with a predetermined value. Other tier structures are possible and are fully contemplated. For instance, a value of a coupon can go up with each confirmation. For instance, a coupon for a mass consumer article such as a laundry detergent in a local grocery store may gain 1 cent value from its base value of 1 penny at its start with every confirmation. A total of 99 confirmations are required to achieve a maximum discount of $1, but also intermediate values are assigned after each confirmation.

In step 44, the server 205 also initializes the values in the Coupon_keywords table and entered keywords get inserted.

After the database has been created on the server, the server 205 then activates the coupon in step 46. This means the coupon will reveal itself when a database is searched. At this point, the coupon is available on a website of coupons. When a user wants to see what coupons are available, the user searches the website with keywords. The search lists all coupons based on a search of the keywords stored in the Coupon_keywords table in the database. Other criteria for a search may also be set. For instance a location criterion, for instance based on a location of the user can be applied.

In one embodiment of the present invention, all valid confirmations related to a Coupon are aggregated, incremented and issued in a single group. A valid confirmation means that a confirmation meets some of the pre-set requirements. For instance, a confirmation from Australia or China is not accepted on a coupon that is being posted for a service or product in New York City. This prevents that unlikely consumers will increase the value of a coupon. However, there are no restrictions or conditions how a valid confirmation contributes the total number of confirmations and all valid confirmations related to a Coupon add to a value of the Coupon. This embodiment of the present invention represents a “one man, one vote approach.” All confirmations share equally in the benefit of the achieved value of the Coupon. Such an approach may be beneficial for a region or nation-wide campaign for a regional or nation-wide brand which executes an undifferentiated sales campaign for a mass consumer product.

### Coupon Strings

In another embodiment of the present invention at least one differentiation takes place between confirmations. For instance, using the above example of the sales campaign in a region or a nation, a distinction is made between ‘general’ valid confirmations related to the coupon and ‘a string related’ confirmation for instance by consumers having a loyalty member card of a grocery chain for instance. Confirmations related to the Coupon by the Loyalty Members obtain a higher value when redeemed by a Loyalty Member at the grocery chain than by the “general public.”

In a further embodiment of the present invention holders of a certain brand credit card may achieve a higher value for a coupon that was incremented in value, for instance if they pay for the product with the specific credit card. In yet a further embodiment of the present invention no actual Coupon has to be submitted by a payer who is entitled to the Coupon with the increased value. Because his name is associated with the Coupon, the payment method via credit card can check in the database of 205 if the payer is associated with the Coupon and the increased Coupon value is automatically deducted from the purchase price.

The inventors of the embodiments of the present invention have recognized that consumers who are interested in Coupons are often a member of a social string of people who share a common interest and actively share information related to that interest, for instance via e-mail or on social networks such as Facebook. These ‘stringed’ consumers by using their on-line social networking skills and capabilities can extend the number of consumers that will confirm a Coupon. For instance by activating the “Like” button as it is known in Facebook, which in such an embodiment will create a confirmation and will share the Coupon with other Facebook users. A consumer herein is a person in one embodiment of the present invention who is either pursuing, and/or confirming and/or reviewing and/or distributing a coupon or information related to the coupon. However, nothing has to be purchased by a consumer to search, confirm, download or distribute a coupon or information related to a coupon. In a further embodiment of the present invention, a consumer may be a computing device. The steps to be taken by a consumer to find a coupon related to a product or service, to assess that a coupon value can be increased by confirming a coupon and to enhance the potential value of a coupon by forwarding it or a link to an address list and downloading a coupon can be programmed to be performed by a computing device.

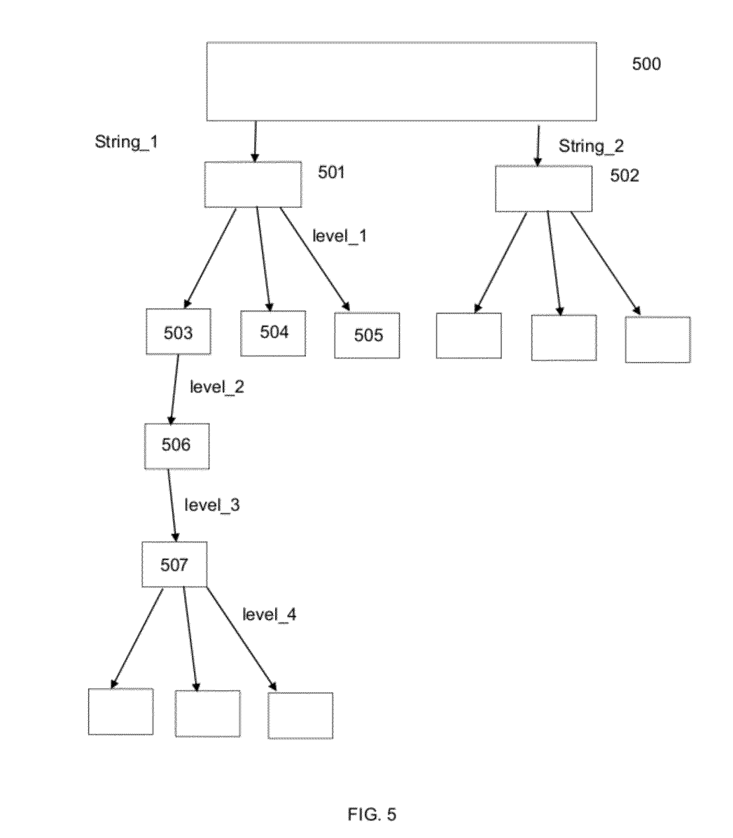

A string for a Coupon is illustrated in FIG. 5. A Coupon, or Coupon information is stored on and displayed from a web page 500. It is viewed on a first computing device 501 in a first string and on a second computing device 502 in a second string. The computing device 501 starts the first string at level_1, by enabling or sharing the coupon or related data with one or more contacts or ‘friends’ (for instance 503, 504 and 505) to also view the Coupon, thus allowing 503-505 to confirm the Coupon and contribute to incrementing the value of the Coupon. Such confirmation can for instance be activating an “Like” or a special “Confirm” button.

There are several ways to ‘Confirm’ a coupon. In one way a Coupon can be confirmed by viewing it. In another way, a coupon can be confirmed by activating a button, for instance carrying a text “Confirm.” A Coupon can also be confirmed by forwarding it or sharing it with other consumers. In one embodiment of the present invention confirming and sharing are the same activity. In another embodiment of the present invention confirming and sharing are different activities.

The String_1 can end with 503-505 at level_1. For instance 504 and 505 may confirm the coupon, but they don't share it with other users. In one embodiment of the present invention, each computing device in String_1 is given an opportunity to start a new level. For instance a user on computing device 503 enables or shares a next level, level_2, with at least a computing device or computer user 506, who is not in a previous level.

Such enabling or sharing can be pushing a “Share” button which enables an application, for instance a Facebook application. Such a Facebook application may include the steps of posting an image and/or a description and/or a link to the server 205 related to the Coupon. As part of the activating the application a new code or id may be associated with the link, so the server 205 can determine that a new level has been started and that confirmations come from a new level. The server at least maintains the id of the start of a string for all confirmations in the string.

A user on a computing device 506 starts a new level level_3 which includes a computing device 507 which starts a new level level_4.

Because the consumers in the levels are connected in a social network, the value of a confirmation from a member of such a string or community with levels is possibly higher than from a set of un-connected consumers. For instance, all consumers in a set of levels favor a certain musical style. A posting or enabling of a coupon related to a recently released music CD possibly with samples and with an endorsement of members in a level may receive serious attention and with a willingness to buy, which is enhanced by a Coupon which increases in value after confirmation by consumers in the levels in the string. In one embodiment of the present invention and as a further incentive, a Coupon has a progressive increment of value after a first or a second round or levels of increments. For instance a Coupon has a value of $0.25 after 10 confirmations in a first level of a string, which increases to $0.50 for the next 5 confirmations and still increases to $1 for yet the next 5 confirmations. This progressive increment will incentivize members in a string to further push the extension of the string. Levels may coincide with tiers; they may also be different from tiers.

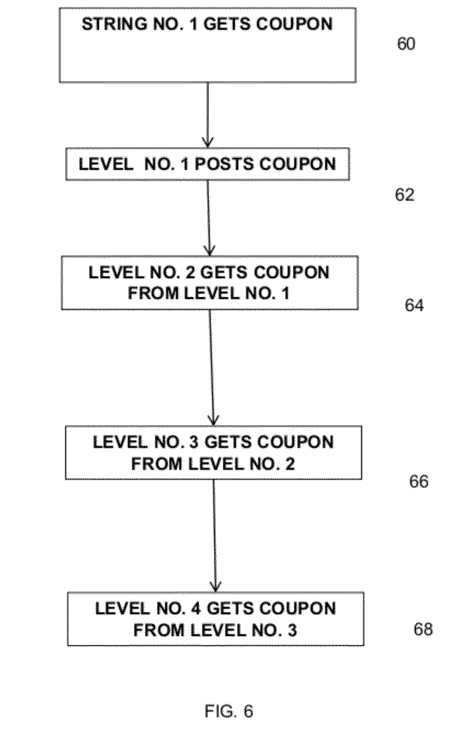

Referring now to FIG. 6, in step 60, a first user selects a coupon from the database and starts a first string. It step 62, the coupon can be posted by the first user. Posting by the first user means that the coupon is available for review by contacts or friends of the first user. In a string of e-mails, posting means that an e-mail containing a link to the coupon is included in the e-mail. A recipient of the e-mail can click on the link which in one embodiment of the present invention brings the recipient to a web page with a display of the coupon, potentially with further information on the offer related to the coupon, which may be hosted on server 205. Steps 64, 66 and 68 illustrate how strings are extended by different levels.

In one embodiment of the present invention a counter related to the Coupon is incremented due to the visit by a recipient to the web page with the coupon. The counter is preferably only incremented when a visit by the recipient has not previously incremented the counter of the Coupon before, so that only unique visits of recipients contribute to the incrementing of the counter. In another embodiment of the present invention the recipient after clicking on the link in the e-mail also has to activate a button or a link on the web page. This ensures that the recipient has at least some exposure to the offer associated with the Coupon.

The recipient in one embodiment of the present invention is provided with access to the Coupon after it has reached its final and maximized value. In a further embodiment of the present invention, the Coupon can be directly downloaded from the web page by the recipient of the e-mail. The Coupon at that stage may have an achieved face value that is associated with the Coupon at redemption. In one embodiment of the present invention, the Coupon may have associated with it a redemption value at the time of viewing or downloading. However, in a further embodiment the string of recipients of e-mails or alternatively of a string of confirmations of the Coupon is still evolving and the value of the Coupon may further increase. In such an embodiment, a redemption value of a Coupon is determined at the time of redemption of the Coupon, based on the achieved value of the Coupon at that time.

In yet a further embodiment of the present invention, a recipient when visiting the web page with the Coupon information is requested to provide identification data, which may include a username or an e-mail address in order to receive a Coupon or access to a Coupon once its final value has been established.

In a further embodiment of the present invention, the recipient of an e-mail with a link to a Coupon web page can extend a string of recipients by sending an e-mail with a link to the Coupon web page to his/her own contacts or friends, presumably with at least one contact which was not already included in the current string.

In yet a further embodiment of the present invention, an e-mail contains a link that when activated sends an e-mail, including the e-mail address to a server. This e-mail constitutes a request for a Coupon which will be sent by the server by e-mail to the e-mail address. The e-mail address provides the server with a unique identification of the request.

As discussed above, some form of unique and identifying information may be required to gain access to a Coupon web page. In one embodiment of the present invention, the unique and identifying information of the recipient is applied in the database to check that the recipient related to a specific Coupon is a unique recipient so a counter related to the Coupon to determine a new value can be incremented.

In one embodiment of the present invention, access to a Coupon so that it can be increased in value is only possible through signing on to an application or a web page. Such an application or web page in a further embodiment of the present invention is a web page that hosts Coupons. Such an application or web page in yet a further embodiment of the present invention is a social network such as Facebook, or any other social network that requires a sign-in by a user from a computing device.

In one embodiment of the present invention, the server 205 hosts a coupon or a representation or a link of a coupon. A coupon may for instance reside on a server 206 and server 205 may host a link to the coupon on 206. A user 202 working on computing device 201 views the coupon on 205 or via 205. In general, a coupon or an offer provided with a coupon can be viewed as a text or an image or a web page generated from or via 205, transmitted via network 200 and viewed on device 201. For instance a web page with a coupon generated by 205 may be displayed in a browser on device 201. The user 202 who views the offer likes the offer and is interested in a coupon. User 202 confirms his/her interest with a confirmation on 201.

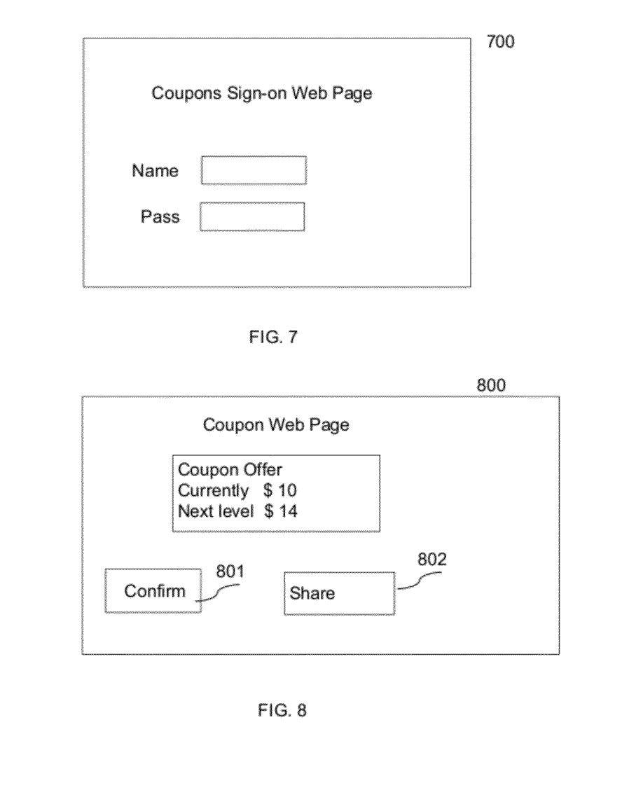

This is illustrated in FIGS. 7 and 8. One would like to prevent that a single user sends out an unlimited number of confirmations to increase a coupon value. One would like to have different users reviewing the offer. In order to base an increase of value on confirmations by different users it is desirable to be able to identify the users. Furthermore, in one embodiment of the present invention only users who have viewed and confirmed the coupon will be entitled to the increased value. In yet a further embodiment of the present invention, users in a defined string achieve a certain increased value of the coupon. Only users in that defined string are entitled to a coupon of the achieved value. Accordingly, in one embodiment of the present invention, a user is identified with a unique identification that is associated with a confirmation of the coupon.

As illustrated in FIG. 7, in one embodiment of the present invention a user signs on to a web page 700 that will host the coupon and potentially additional information on or via the server 205. The user can sign on via the known method of providing a user name and a password. From that moment forward, all activities by the user on the web page can be administered and stored in a database. FIG. 8 illustrates that a web page related to a specific coupon is being displayed with information related to the coupon. This may include the coupon offer details, the current value of the coupon and the next value level that can be achieved. Other information may also be displayed. For instance, the number of users that have to confirm until the next value level is achieved may be displayed. The maximum achievable value level may also be displayed. The web page in a further embodiment of the present invention has a confirmation button 801 that, when activated generates a confirmation for the coupon that is associated with the user and that is stored in a database.

To prevent mindless pushing or confirming, a message such as a commercial video, may be provided that has to be viewed in its entirety before the confirmation is valid. This can be achieved by playing the message as soon as web page 800 is opened and disabling the button 801 until the message has finished. At that stage the button 801 becomes enabled and can be activated by the user. Other enabling schemes are possible and are fully contemplated.

Once the button 801 is activated the confirmation is sent to server 205 where it is associated with the coupon and with the user ID and stored in the database. In a further embodiment of the present invention, the user ID is also associated with a specific string or community. The server 205 checks if an incremental number of users has sent a confirmation related to the coupon, possibly users in one string. The server 205 determines that an incremental number of users has indeed confirmed the coupon and the server increases the value of the coupon with an incremental value. The web page 800 is updated and a new value is posted. In one embodiment, only users who have sent a confirmation related to the coupon will be enabled to download the coupon with the increased value. This can be enforced by applying the data in the database. The server can check if a user has sent a confirmation related to the coupon before it enables the user to download or to access the coupon with the increased value.

In a further embodiment of the present invention, also users who have not previously confirmed a coupon and after a coupon has reached its maximum value, are enabled to download a coupon. These users may be required to confirm the coupon, even if it does not contribute to an increase in value, before being enabled to access the coupon.

In another embodiment of the present invention, web page 800 is provided with a link or button 802 which shares the Coupon on a web page associated with the user that activates 802 with a number of contacts of the user. While activating 801 sends a confirmation to the server 205, activating 802 causes a copy of the Coupon and/or Coupon information to appear on the web page associated with the user. This allows contacts or ‘friends’ in the new string who were earlier not in a Coupon string to view the Coupon and confirm. Activating 802 enables sharing of the Coupon and also includes the confirmation by the coupon for the user.

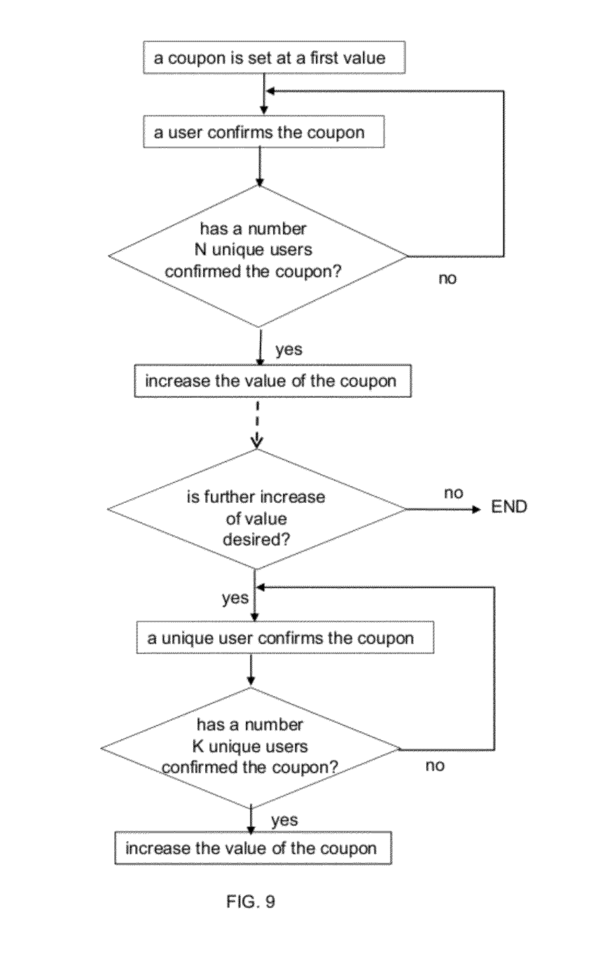

Once a predetermined number of confirmations has been achieved the server may stop evaluating new confirmations. However, a server may also start a new round of confirmations, with a new requirement of a number of unique users that have to confirm the coupon and the new, increased value of the coupon after the new number of unique users has confirmed the coupon. One way of implementing this process is illustrated in FIG. 9.

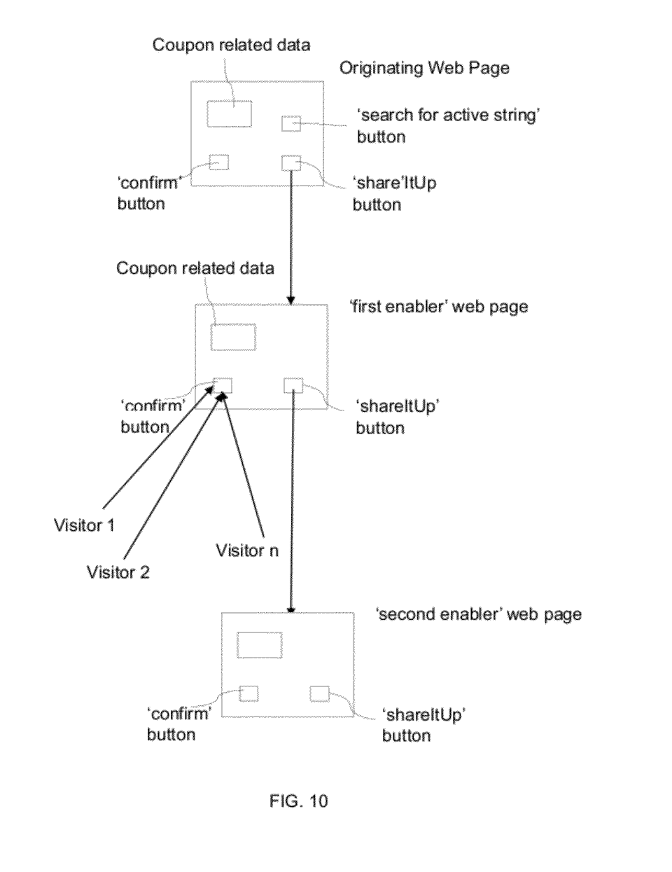

In one embodiment of the present invention, the steps as for instance illustrated in FIG. 9 take place on one or more web pages. In another embodiment of the present invention, some or all of the steps take place via e-mail or other forms of text messaging or phone messaging. FIG. 10 illustrates the creation of levels in a string by activating a ‘share’ button on a web page. Activating the ‘share’ button includes confirmation of the Coupon.

A coupon herein is defined as a potential discount on a future purchase. In a further embodiment of the present invention, a coupon is defined as a discount that is awarded after a purchase has been made. A similar tiered and leveled approach as described herein can be applied in this further embodiment. Herein, a product or service is posted and is confirmed by a consumer who also pays for this product or service. The discount is calculated based on a number of consumers who purchase the product or service, preferably in a defined time period. The discount depends on achieving at least two tiers of consumers. For instance, a first group of consumers buys the product or service and receives a discount of $10 each after 10 people have bought the product or service. After an additional 5 consumers have purchased the product or service within 48 hours an additional $5 discount is awarded to the at least 15 consumers.

The methods provided herein as an aspect of the present invention provide powerful marketing tools for merchants to market their products and/or services in a cost effective way on-line. Most of the methods are fully automated after the initial set-up has been done. As one aspect of the present invention, systems and methods are provided that allow a vendor or merchant to set up an on-line coupon with an incrementing value tier structure.

A vendor who wants to post a coupon signs-on to a server, such as server 205, through a computing device that is connected to the Internet. The vendor may select from a menu an option to create a coupon, for which the vendor is directed to a user interface of which an illustrative example is shown in FIG. 11. This example is a coupon for a pizza. The vendor fills out the deal text “$2 off your purchase of a plain pizza”. The vendor selects that the coupon should be printable, has tiers, has a value off, is in USD. The regular price of 13.99 is provided as well as a start and end date and a ‘terms of use.” The initial coupon value is 2.00 and is increased to 2.25 after 10 people have confirmed. After 50 people have confirmed the value becomes 2.50. The vendor may add a new tier if so desired. However, the vendor may also ‘create’ the coupon after 2 tiers have been set. Activating the ‘create’ button initializes the database and enables the start of a coupon campaign.

After creating the Social Coupon, the coupon may be posted on the server 205. The coupon may also be posted on the web page of the vendor, and may have a link to server 205. The coupon and the vendor interface may also be part of a program, for instance programmed in Java or any other computer language that can be installed on a server that hosts a web page. In one embodiment of the present invention, the Coupon and the vendor interface are an application hosted or accessed through a social network such as Facebook or LinkedIn®. In another embodiment of the present invention, the vendor interface is provided as a service hosted on a server. Other implementations are contemplated and the herein provided examples should not be considered as limiting. A vendor is responsible for maintaining data. The application in a further embodiment of the present invention includes a reporting tool that generates reports on a status of a coupon.

In one embodiment of the present invention, methods related to a Coupon as provided herein are hosted on a server 205 which is operated by or on behalf of an organization which is not the vendor of the product or article that is the subject of the Coupon. This organization is compensated by the vendor for enabling the vendor to obtain the benefits of creating Coupons on-line and providing the marketing benefits to the Vendor of offering a social Coupon. Compensation can be a straight forward fee. In one embodiment of the present invention, the vendor pays from an account when the Coupon is created or when the vendor signs on to a server. In another embodiment of the present invention, the organization is compensated based on the number of confirmations that a Coupon receives. In yet another embodiment of the present invention, the organization provides the software to a third organization which provides the on-line Coupon services and is compensated by the third organization. Other compensation schemes are fully contemplated.

One aspect of the present invention is the distribution of a coupon to a consumer who has confirmed the coupon. In one embodiment of the present invention, a consumer prints or downloads a coupon that is posted to a consumer right after the confirmation. Because that coupon is tied to a unique confirmation (to prevent double or multiple confirmations by a single consumer) only one coupon related to an offer is allowed to a single consumer. After the coupon is printed, it is no longer posted to that consumer or is no longer distributed to that consumer. It may occur that a consumer prints a coupon at not its maximum value. To offer a consumer a maximum value of a coupon, the consumer is allowed to postpone downloading or printing of the coupon at a later stage. At that stage a coupon is posted or distributed to a consumer after a sign-in, at which time a higher value has been achieved. In yet a further embodiment of the present invention, a coupon contains an achieved value, which the consumer will certainly get at time of purchasing. The printed version of the coupon also contains higher values of the coupon that may be obtained before the coupon expires. During the purchase of the product or the service, the vendor checks and provides as a discount the achieved value of the coupon at that time, which the vendor can check on-line.

The above refers to distributing a coupon via a web page. However, a Coupon in accordance with an aspect of the present invention can also be distributed in an e-mail or an instant message. Distribution of a Coupon by e-mail also has the above issues. In one embodiment of the present invention, a consumer receives an e-mail with a Coupon immediately or substantially immediately after confirmation of the Coupon. A consumer may also opt-in to have the Coupon sent at the time a maximum value has been achieved. In e-mail distribution, it is also possible to send the consumer an e-mail with a link. The link always has a Coupon with the current value that is achieved. Accordingly, a consumer can download or print the Coupon around the time a purchase is made. After downloading or printing of the Coupon, the link related to the Coupon and a specific Consumer goes “inactive” after the Coupon has been downloaded or printed and thus the Coupon has been distributed.

In accordance with various aspects of the present invention, the value of the coupon can be set by a percentage in relation to the initial value of the coupon, by a fixed number of units or by a fixed dollar value. The screen shown in FIG. 11 can be modified as necessary to accommodate these parameters.

A coupon thus is distributed uniquely to a consumer with at least its lowest value and possibly with an increased value before a purchase related to the coupon is made by the consumer.

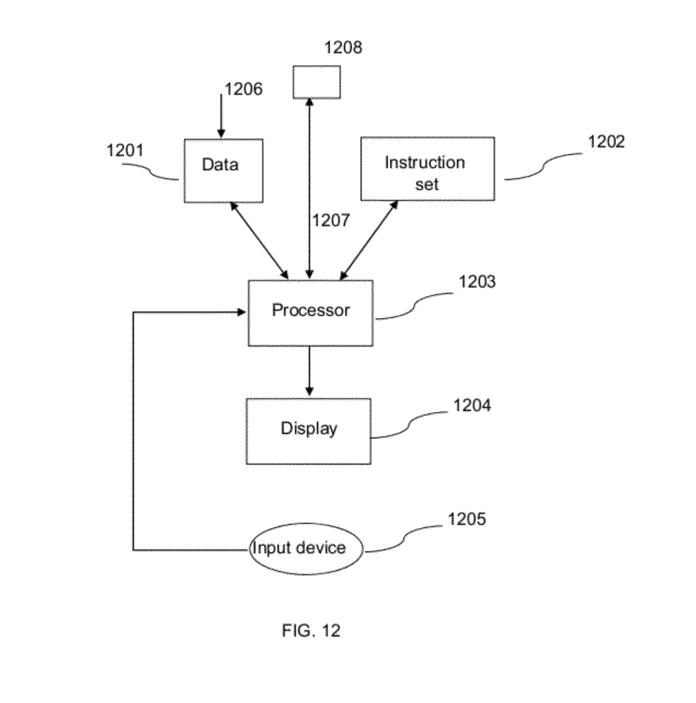

The methods that are aspects of the present invention can be executed by a system or computing device as shown in FIG. 12. The system is provided with data 1201 which is provided on an input 1206. An instruction set or program 1202 executing the methods of the present invention is provided and combined with the data in a processor 1203, which can process the instructions of 1202 applied to the data 1201. Instructions and data to be applied by the processor can be stored in a memory. A Coupon as disclosed herein can be stored in the memory. Any signal resulting from the processor can be outputted on a device 1204. Such a device for instance can be a display. However, in an operational situation such device may also be an output device to provide a message to a network or a network connection to another computing device. The processor can be dedicated hardware. However, the processor can also be a CPU or any other computing device that can execute the instructions of 1202. An input device 1205 like a mouse, or track-ball or other input device may be present to allow a user to select an object on a display. The input device may also be a keyboard to enter data. The input device may also be used to start or stop instructions and activate applications on the processor. In a further embodiment of the present invention the system or computing device is connected via a connection 1207 to a network, for instance via a network device 1208 which may implement a network interface.

Thus, in summary, in accordance with an aspect of the present invention, a system to provide a coupon related to an organization to a plurality of users is provided. The system includes a plurality of computing devices; a server comprising a processor and a memory; a network connecting the plurality of computing devices and the server. The server is operable to send a user interface to one of the plurality of computing devices in response to a request to generate a coupon; receive information requested in the user interface from the one of the plurality of computing devices, including an initial value of the coupon, a first tiered value of the coupon and the number of required users to obtain the first tiered value of the coupon; and store the initial value of the coupon, the first tiered value of the coupon, the number of required users to obtain the first tiered value of the coupon in the memory. The server can also transmit the coupon having a value as determined above.

In accordance with another aspect of the present invention, a system to provide a coupon related to an organization to a plurality of users is provided. The system includes a plurality of computing devices; a server comprising a processor and a memory, the memory storing a first value of a coupon, a second value of a coupon and a third value of a coupon, a first number of required users and a second number of required users; a network connecting the plurality of computing devices and the server. The server is operable to: receive a request for a coupon having a identifier code and each time the request for the coupon having the identifier code is received, the server increments a number of users associated with the identifier code. It also checks to see if the number of users associated with the identifier code exceeds the first number of required users or the second number of required users and sets the value of the requested coupon (a) in accordance with the first value of the coupon if the number of users associated with the identifier code is less than the first number of required users (b) in accordance with the second value of the coupon if the number of users associated with the identifier code is greater than the first number of required users but less than the second number of required users and (c) accordance with the third value of the coupon if the number of users associated with the identifier code is greater than the second number of required users.

While there have been shown, described and pointed out fundamental novel features of the invention as applied to preferred embodiments thereof, it will be understood that various omissions and substitutions and changes in the form and details of the methods and systems illustrated and in its operation may be made by those skilled in the art without departing from the spirit of the invention. It is the intention, therefore, to be limited only as indicated by the scope of the claims appended hereto.

1-20. (canceled)

21. A system to provide a coupon related to an organization to a plurality of users, comprising:
a plurality of computing devices;
a server comprising a processor and a memory;
a network connecting the plurality of computing devices and the server, wherein the server is operable to:
sending a user interface to one of the plurality of computing devices in response to a request to generate a coupon;
receiving information requested in the user interface from the one of the plurality of computing devices, including an initial value of the coupon, a first tiered value of the coupon and the number of required users to obtain the first tiered value of the coupon; and
storing the initial value of the coupon, the first tiered value of the coupon, the number of required users to obtain the first tiered value of the coupon in the memory.

22. The system of claim 21, wherein the initial value of the coupon is non-zero.

23. The system of claim 21, wherein the first tiered value of the coupon is set by a percentage in relation to the initial value of the coupon, by a fixed number of units or by a fixed dollar value.

24. The system of claim 21 wherein the value of the coupon and the first tiered value of the coupon is a dollar value or a product unit value.

25. The system of claim 21, comprising the server:
receiving information provided in the user interface from the one of the plurality of computing devices including a second tiered value of the coupon and the number of required users to obtain the second tiered value of the coupon; and
storing the second tiered value of the coupon and the number of required users to obtain the second tiered value of the coupon in the memory.

26. The system of claim 25, comprising the server:
receiving information requested in the user interface from the one of the plurality of computing devices, including a third tiered value of the coupon and the number of required users to obtain the third tiered value of the coupon; and
storing the third tiered value of the coupon and the number of required users to obtain the third tiered value of the coupon in the memory.

27. The system of claim 21, comprising the server:
receiving an initial request for the coupon from any of the plurality of computing devices; and
creating a coupon string by assigning a unique code to the created coupon, storing the unique code and an associated coupon identification in the memory and initializing the number of users of the coupon string in the memory.

28. The system of claim 25, comprising the server:
receiving another request for the coupon, the request including the unique code;
incrementing the number of users of the coupon, checking the required number of users of the coupon and if the number of users equals the required number of users then incrementing the value of the coupon by the incremental value of the coupon.

29. The system of claim 26, comprising the server distributing the coupon in response to the request for the coupon that includes the unique code.

30. The system of claim 26 wherein before incrementing the number of users, the server determines whether the request is a duplicate request.

31. The system of claim 26, wherein the another request is received from an email address, from Facebook, via instant messaging, via text message or via phone.

32. A system to provide a coupon related to an organization to a plurality of users, comprising:
a plurality of computing devices;
a server comprising a processor and a memory, the memory storing a first value of a coupon, a second value of a coupon and a third value of a coupon, a first number of required users and a second number of required users;
a network connecting the plurality of computing devices and the server;
wherein the server is operable to:
receive a request for a coupon having a identifier code;
each time the request for the coupon having the identifier code is received, incrementing a number of users associated with the identifier code, checking to see if the number of users associated with the identifier code exceeds the first number of required users or the second number of required users, setting the value of the requested coupon (a) in accordance with the first value of the coupon if the number of users associated with the identifier code is less than the first number of required users (b) in accordance with the second value of the coupon if the number of users associated with the identifier code is greater than the first number of required users but less than the second number of required users and (c) accordance with the third value of the coupon if the number of users associated with the identifier code is greater than the second number of required users.

33. The system of claim 32, wherein the first value of the coupon is non-zero.

34. The system of claim 32, wherein the second value of the coupon is set by a percentage in relation to the first value of the coupon, by a fixed number of units or by a fixed dollar value.

35. The system of claim 34, wherein the third value of the coupon is set by a percentage in relation to the second value of the coupon, by a second fixed number of units or by a second fixed dollar value.

36. The system of claim 32, wherein the server distributes the requested coupon in accordance with the first value, the second value or the third value.

37. The system of claim 32, wherein before incrementing the number of users, the server determines whether the request is a duplicate request.

38. The system of claim 32, wherein the request for a coupon is received from an email address, from Facebook, via instant messaging, via text message or via phone.

39. The system of claim 36, wherein the coupon is valid during a defined period.

40. The system of claim 36, wherein the coupon is associated with a credit card.

41. The system of claim 36, wherein a value of the coupon is deducted from a payment with the credit card.

42. A method to provide a coupon, comprising:
storing a first value of a coupon, a second value of a coupon and a third value of a coupon, a first number of required users and a second number of required users in memory;
a processor receiving a request for a coupon having a identifier code; and
each time the request for the coupon having the identifier code is received, the processor incrementing a number of users associated with the identifier code, checking to see if the number of users associated with the identifier code exceeds the first number of required users or the second number of required users, setting the value of the requested coupon (a) in accordance with the first value of the coupon if the number of users associated with the identifier code is less than the first number of required users (b) in accordance with the second value of the coupon if the number of users associated with the identifier code is greater than the first number of required users but less than the second number of required users and (c) accordance with the third value of the coupon if the number of users associated with the identifier code is greater than the second number of required users; and
the processor distributing the requested coupon in accordance with the first value, the second value or the third value.
